(19) United States
(12) Patent Application Publication
(10) Pub. No.: US 2025/0281936 A1
(43) Pub. Date: Sep. 11, 2025

(54) APPARATUS AND METHOD FOR MANUFACTURING BASE LAYER SLURRY

(71) Applicants: Hyundai Motor Company, Seoul (KR); Kia Corporation, Seoul (KR)

(72) Inventors: Soo Bin Yoon, Seoul (KR); Young June Park, Seoul (KR)

(21) Appl. No.: 18/811,288

(22) Filed: Aug. 21, 2024

(30) Foreign Application Priority Data
Mar. 8, 2024 (KR) 10-2024-0033388

(51) Int. Cl. B04B 3/02; B04B 7/16

(52) U.S. Cl. CPC B04B 3/025; B04B 7/16

(57) ABSTRACT

Provided is an apparatus for manufacturing base layer slurry for forming a porous base layer, the apparatus including a base container configured to accommodate base slurry including first slurry particles, and second slurry particles having larger particle sizes than the first slurry particles, and a centrifugation part provided in the base container and configured to centrifuge the base slurry into first base layer slurry including the first slurry particles and second base layer slurry including the second slurry particles, thereby obtaining an advantageous effect of simplifying structure and manufacturing process and improving productivity.

### CROSS-REFERENCE TO RELATED APPLICATION

This application claims under 35 U.S.C. § 119(a) the benefit of Korean Patent Application No. 10-2024-0033388 filed in the Korean Intellectual Property Office on Mar. 8, 2024, the entire contents of which are incorporated herein by reference.

### BACKGROUND

### Technical Field

Embodiments of the present disclosure relate to an apparatus and method for manufacturing a base layer slurry, and more particularly, to an apparatus and method for manufacturing a base layer slurry that are capable of simplifying the structure and manufacturing process and improving productivity.

### Background

There is a consistently increasing need for research and development in alternative energy to address global warming and the depletion of fossil fuel. Hydrogen energy is gaining attention as a practical solution to environmental and energy issues.

In particular, hydrogen is in the spotlight as a future energy carrier due to its high energy density and properties suitable for grid-scale applications.

A water electrolysis stack, which is an electrochemical device, produces hydrogen and oxygen by electrochemically decomposing water. This stack may be configured by stacking several tens or even hundreds of water electrolysis cells (unit cells) in series.

A membrane-electrode assembly (MEA) is positioned at the innermost side of the unit cell of the water electrolysis stack. The membrane-electrode assembly includes a perfluorinated sulfonic acid ionomer-based electrolyte membrane capable of moving hydrogen ions (protons), with an anode electrode and a cathode electrode respectively disposed on two opposite surfaces of the electrolyte membrane.

In addition, a porous transport layer (PTL), a gas diffusion layer (GDL), and a gasket may be stacked on each of the outer portions (outer surfaces) of the membrane-electrode assembly (MEA) on which the anode and the cathode are positioned. A separator (or bipolar plate) may be disposed on an outer side (outer surface) of the porous transport layer (PTL) and the gas diffusion layer (GDL). The separator includes flow paths (flow fields) through which a reactant, a coolant, and a product produced by a reaction flow, or it may have a structure that can substitute for the flow paths.

### SUMMARY

The present disclosure has been made in an effort to provide an apparatus and method for manufacturing a base layer slurry, which are capable of simplifying a structure and manufacturing process and improving productivity.

In particular, in an aspect, the present disclosure has been made in an effort to simplify a process of manufacturing different types of base layer slurry including slurry particles having different particle sizes and improve productivity and production efficiency.

Among other things, in an aspect, the present disclosure has been made in an effort to simultaneously manufacture first base layer slurry including first slurry particles and second base layer slurry including second slurry particles having larger particle sizes than the first slurry particles by means of a single process.

In an aspect, the present disclosure has also been made in an effort to reduce costs and minimize the time required to produce different types of base layer slurry.

In an aspect, the present disclosure has also been made in an effort to improve the safety and reliability and minimize the risk of the occurrence of a fire in accordance with the classification of slurry particles.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides an apparatus for manufacturing base layer slurry for forming a porous base layer, the apparatus including: a base container configured to accommodate base slurry including first slurry particles, and second slurry particles having larger particle sizes than the first slurry particles; and a centrifugation part configured to centrifuge the base slurry into first base layer slurry including the first slurry particles and second base layer slurry including the second slurry particles.

According to the embodiment of the present disclosure, the centrifugation part may include: a centrifugation container provided in the base container and having a mesh portion through which only the first slurry particles, among the first and second slurry particles, pass; a centrifugal force application part configured to apply a centrifugal force to the base slurry; and an opening/closing member configured to selectively open or close the mesh portion.

According to the embodiment of the present disclosure, the opening/closing member may close the mesh portion when the first base layer slurry and the second base layer slurry are separated with the centrifugation container interposed therebetween.

According to the embodiment of the present disclosure, the mesh portion may include a plurality of mesh holes through which the first slurry particles pass.

According to the embodiment of the present disclosure, the mesh portion may be provided as a plurality of mesh portions spaced apart from one another in a circumferential direction of the centrifugation container.

According to the embodiment of the present disclosure, the opening/closing member may be rotatable from a first position at which the opening/closing member closes the mesh portion to a second position at which the opening/closing member opens the mesh portion.

According to the embodiment of the present disclosure, the opening/closing member may include: a body portion configured to be rotatable relative to the centrifugation container in a circumferential direction of the centrifugation container; and a passage portion provided in the body portion so that the first slurry particles pass through the passage portion, the body portion may close the mesh portion at the first position, and the passage portion may be disposed to communicate with the mesh portion at the second position.

According to the embodiment of the present disclosure, the body portion may be rotatable in the centrifugation container.

According to the embodiment of the present disclosure, the apparatus may include a cover configured to selectively open or close an opening portion of the body portion.

According to the embodiment of the present disclosure, the apparatus may include a handle part connected to the body portion and configured to rotate the body portion.

According to the embodiment of the present disclosure, the centrifugal force application part may include: a shaft configured to be rotatable relative to the centrifugation container; and a blade connected to the shaft and configured to rotate the base slurry.

Another exemplary embodiment of the present disclosure provides an apparatus comprising: a container comprising a mesh portion, and an opening/closing member configured to selectively open or close the mesh portion. The mesh portion may be provided as a plurality of mesh portions spaced apart from one another in a circumferential direction of the container. The opening/closing member may be rotatable from a first position at which the opening/closing member closes the mesh portion to a second position at which the opening/closing member opens the mesh portion. The opening/closing member may be rotatable inside the container.

Another exemplary embodiment of the present disclosure provides a method of manufacturing base layer slurry for forming a porous base layer, the method comprising: preparing base slurry comprising first slurry particles, and second slurry particles having larger particle sizes than the first slurry particles; and placing the base slurry in a container with a mesh portion configured to allow only the first slurry particles to pass through; applying a centrifugal force to the base slurry to separate the first and second slurry particles; selectively open or close the mesh portion using an opening/closing mechanism to control a passage of the first slurry particles.

The method may further comprise blocking the first base layer slurry and the second base layer slurry by closing the mesh portion during the centrifuging to keep the base slurry separated. The method may further comprise individually extracting the first base layer slurry and the second base layer slurry after the centrifuging by using a cover to selectively open or close an opening portion of the container. The mesh portion may be provided as a plurality of mesh portions spaced apart from one another in a circumferential direction of the container. The opening/closing member may be rotatable from a first position at which the opening/closing member closes the mesh portion to a second position at which the opening/closing member opens the mesh portion.

### BRIEF DESCRIPTION OF THE DRAWINGS

FIG. 1 is a view for explaining an apparatus for manufacturing a base layer slurry according to an embodiment of the present disclosure.

FIG. 2 is a view for explaining a centrifugation part of the apparatus for manufacturing a base layer slurry according to the embodiment of the present disclosure.

FIGS. 3 to 7 are views for explaining a process of manufacturing base layer slurry by using the apparatus for manufacturing a base layer slurry according to the embodiment of the present disclosure.

FIG. 8 is a view for explaining a porous base layer manufactured by the apparatus for manufacturing a base layer slurry according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

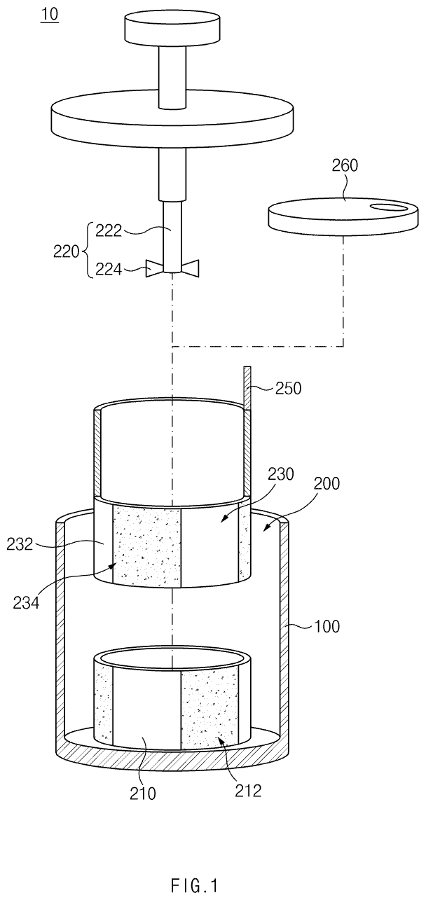

With reference to FIGS. 1 to 8, an apparatus 10 for manufacturing base layer slurry for forming a porous base layer according to an embodiment of the present disclosure includes a base container 100 configured to accommodate base slurry BS including first slurry particles and second slurry particles having larger particle sizes than the first slurry particles. The apparatus also includes a centrifugation part 200 provided in the base container 100 and configured to centrifuge the base slurry BS into first base layer slurry S1 including the first slurry particles and second base layer slurry S2 including second slurry particles.

For reference, a porous base layer manufactured by the apparatus 10 for manufacturing base layer slurry according to the embodiment of the present disclosure may constitute an electrochemical device together with a membrane electrode assembly (MEA) 100.

In this case, the electrochemical device is defined as including both a water electrolysis stack configured to produce hydrogen and oxygen by electrochemically decomposing water and a fuel cell stack configured to generate electrical energy through a chemical reaction of fuel (e.g., hydrogen).

Hereinafter, an example will be described in which the electrochemical device according to the embodiment of the present disclosure is used as the water electrolysis stack that produces hydrogen and oxygen by decomposing water through an electrochemical reaction.

This is to ensure the performance and operational efficiency of the electrochemical device and to improve its durability and reliability.

That is, in order to ensure the stable performance and operational efficiency of the electrochemical device and ensure the durability (durability of the membrane electrode assembly), one surface of the porous base layer, which is in contact with the membrane electrode assembly, needs to have comparatively low surface roughness (e.g., first surface roughness or a first pore size), and the other surface of the porous base layer (the other surface of the porous base layer facing the separator) needs to have relatively high surface roughness (e.g., second surface roughness higher than the first surface roughness or a second pore size larger than the first pore size).

To this end, recently, attempts have been made to manufacture porous base layers by stacking different types of base layers having different surface roughness (or different pore sizes).

Meanwhile, in order to form different types of base layers having different surface roughness, it is necessary to prepare two types of base layer slurry (base layer manufacturing slurry) including slurry particles with different particle sizes.

However, in the related art, manufacturing different types of base layer slurry requires separate slurry manufacturing devices for each type of slurry, and each type must be produced through distinct manufacturing processes. This leads to complications in the structure and manufacturing process, resulting in degraded productivity and production efficiency, as well as increased manufacturing costs.

Moreover, because titanium used for slurry particles has very high reactivity, there is a problem in that the risk of the occurrence of a fire is high during a process of classifying slurry particles (a process of sorting slurry particles for respective particle sizes).

However, according to the embodiment of the present disclosure, the centrifugation part 200 centrifuges the base slurry BS, which includes different types of slurry particles (the first and second slurry particles having different particle sizes), into different types of base layer slurry (the first base layer slurry and the second base layer slurry). Therefore, it is possible to obtain an advantageous effect of simplifying the structure and manufacturing process and improving the productivity and production efficiency.

Among other things, according to the embodiment of the present disclosure, the first base layer slurry S1, which includes the first slurry particles, the second base layer slurry S2, which includes the second slurry particles having larger particle sizes than the first slurry particles, are simultaneously manufactured by a single process. Therefore, it is possible to obtain an advantageous effect of remarkably minimizing the time required to produce different types of base layer slurry and reducing the costs.

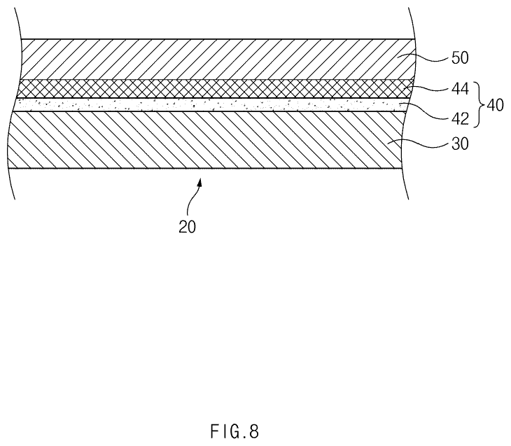

For reference, with reference to FIG. 8, the water electrolysis stack (electrochemical device) may be provided by stacking a plurality of unit cells in a reference stacking direction.

More specifically, the unit cell may include a reaction layer 20 configured to induce an electrochemical reaction of a target fluid (e.g., water), and separators 50 respectively stacked on one surface and the other surface of the reaction layer 20. The water electrolysis stack may be configured by stacking the plurality of unit cells in the reference stacking direction and then assembling endplates (not illustrated) to the two opposite ends of the plurality of unit cells.

For example, the reaction layer 20 may include a membrane electrode assembly (MEA) 30, and porous base layers 40 provided to be in close contact with two opposite surfaces of the membrane electrode assembly 30.

The porous base layer 40 is disposed between the membrane electrode assembly 30 and the separator 50 to uniformly distribute (move or discharge) the target fluid (e.g., water or hydrogen) while serving as an electron movement passage.

In particular, the porous base layer 40 may include a first base layer 42 having a first porosity (first surface roughness) that is in contact with the membrane electrode assembly 30, and a second base layer 44 with a second porosity higher than the first porosity (the second surface roughness higher than the first surface roughness) that is stacked on the first base layer 42 to face the separator 50.

The apparatus 10 for manufacturing base layer slurry according to the embodiment of the present disclosure is provided to manufacture the first base layer slurry S1 for forming the first base layer 42 and the second base layer slurry S2 for forming the second base layer 44 and includes the base container 100 and the centrifugation part 200.

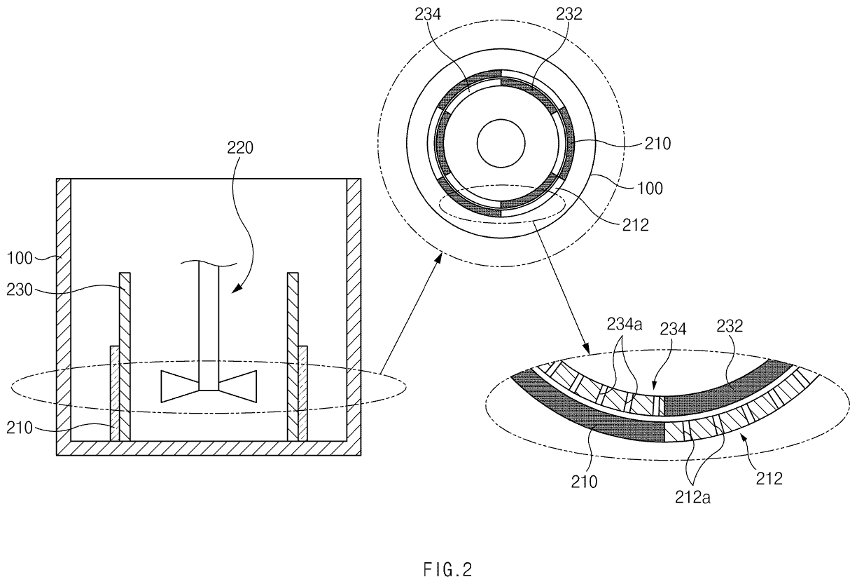

With reference to FIGS. 1 and 2, the base container 100 is configured to accommodate the base slurry BS therein.

The base container 100 may have various structures each having an accommodation space therein. The present disclosure is not restricted or limited by the structure and shape of the base container 100.

For example, the base container 100 may be provided to have an approximately hollow cylindrical shape. According to another embodiment of the present disclosure, the base container may have a quadrangular box shape or other shapes.

The base slurry BS is a raw material for manufacturing the first base layer slurry S1 and the second base layer slurry S2 and includes the first slurry particles, and the second slurry particles having larger particle sizes than the first slurry particles.

The base slurry BS may be provided by mixing various materials in accordance with required conditions and design specifications. The present disclosure is not restricted or limited by the types of materials that constitute the base slurry BS or by the composition ratios of the materials.

For example, the base slurry BS may be provided by mixing the first slurry particles, the second slurry particles, solvents, dispersants, and coupling agents.

Various metal elements may be used as the first slurry particles and the second slurry particles in accordance with required conditions and design specifications. The present disclosure is not restricted or limited by the types and properties of the first slurry particles and the second slurry particles.

According to an exemplary embodiment of the present disclosure, the first slurry particles and the second slurry particles may include titanium family elements. More particularly, titanium family elements may include at least any one of titanium, zirconium, and hafnium.

According to another embodiment of the present disclosure, other metal elements such as nickel or stainless steel may be used, instead of the titanium family elements, as the first slurry particles and the second slurry particles.

Further, the metal element (e.g., the titanium family element) may have various shapes capable of manufacturing the porous base layer 40. The present disclosure is not restricted or limited by the shape and structure of the metal element. For example, the metal element (e.g., the titanium family element) may be provided in a circular shape, an elliptical shape, an atypical shape, or a fiber shape.

The particle sizes (first particle sizes) of the first slurry particles may vary according to required conditions and design specifications. The present disclosure is not restricted or limited by the particle sizes of the first slurry particles.

According to the exemplary embodiment of the present disclosure, the first slurry particle may have a particle size (e.g., an average or mean particle size) of 5 to 20 μm.

If the particle size (first particle size) of the first slurry particle is smaller than 5 μm, there is a problem in that the porosity and pore size of the first base layer 42 are excessively low and small, and the brittleness is high. In contrast, if the particle size (first particle size) of the first slurry particle is larger than 20 μm, the surface roughness of the first base layer 42 increases, which may damage the membrane electrode assembly being in contact with the first base layer 42. Therefore, in certain preferred aspects, the particle size (first particle size) of the first slurry particle may be from about 5 μm to 20 μm.

For reference, the average particle size of the titanium family element may be defined as a grain size of cumulative distribution 50% (D₅₀) in the grain size distribution measured by a particle size analyzer (PSA).

The particle sizes (second particle sizes) of the second slurry particles may be variously changed in accordance with required conditions and design specifications. The present disclosure is not restricted or limited by the particle sizes of the second slurry particles.

According to the exemplary embodiment of the present disclosure, the second slurry particle may have a particle size (e.g., an average or mean particle size) of 21 to 80 μm.

If the particle size (second particle size) of the second slurry particle is smaller than 21 μm, there may be a problem in that the porosity and pore size of the second base layer 44 are excessively low and small, and it is difficult to form a smooth flow of the target fluid (it is difficult to ensure a sufficient transfer flow rate of the target fluid to be transferred to the membrane electrode assembly). In contrast, if the particle size (second particle size) of the second slurry particle is larger than 80 μm, the porosity of the second base layer 44 may be excessively high, the illuminance is high, and the resistance in the water electrolysis stack increases, which may cause a problem of deterioration in performance. In certain preferred aspects, the particle size (second particle size) of the second slurry particle may be from anout 21 μm to 80 μm.

In certain aspects, the second slurry particle may have a mean particle size that is about 1, 2, 3, 4, 5, 6, 7, 8,9, 10, 15 or 20 μm greater than the mean particle size of the first slurry particle.

According to the exemplary embodiment of the present disclosure, the base slurry BS may include the titanium family elements (the first slurry particles and the second slurry particles) of 60 to 98 weight % with respect to the total weight of the base slurry BS.

If the titanium family element content is smaller than 60 weight % with respect to the total weight of the base slurry BS, the distance between the titanium family elements becomes significant during the heat-treating the porous base layer (the first base layer and the second base layer) (a degreasing process and a sintering process). This can cause problems such as the sintering process not being performed smoothly, excessively high porosity of the porous base layer, and low rigidity. In contrast, if the titanium family element content is larger than 98 weight % with respect to the total weight of the base slurry BS, the porosity of the porous base layer is excessively low, and the viscosity of the base slurry BS is excessively high, which causes a problem in which the porous base layer cannot be normally manufactured.

Therefore, the titanium family element content may be defined to be 60 to 98 weight % with respect to the total weight of the base slurry BS. Particularly, the titanium family element content may be defined to be 65 to 85 weight % with respect to the total weight of the base slurry BS. More particularly, the titanium family element content may be defined to be 70 to 80 weight % with respect to the total weight of the base slurry BS.

Various solvents may be used as a solvent contained in the base slurry BS in accordance with required conditions and design specifications. The present disclosure is not restricted or limited by the type and properties of the solvent.

For example, ethanol, toluene, methanol, propanol, butanol, acetone, ketone, cyclohexenone, methyl acetate, ethyl acetate, and the like may be used as the solvent.

According to the exemplary embodiment of the present disclosure, the base slurry BS may include the solvent of 10 to 30 weight % with respect to the total weight of the base slurry BS.

If a solvent content is smaller than 10 weight % with respect to the total weight of the base slurry BS, the viscosity of the base slurry BS is high, and coating properties of a composition (base layer slurry) deteriorate. For this reason, a thickness of the porous base layer may not be uniform, the excessive deviation of porosity and pore sizes may occur for each position of the porous base layer. In contrast, if the solvent content is larger than 30 weight % with respect to the total weight of the base slurry BS, the solvent is excessively evaporated during a process of sintering the porous base layer, which may cause a problem in which the material and devices are contaminated, or it is difficult to satisfy a target thickness, a target porosity, and a target pore size.

Therefore, the solvent content may be defined as 10 to 30 weight % of the total weight of the base slurry BS. Specifically, the solvent content may be defined as 15 to 30 weight % of the total weight of the base slurry BS. More particularly, the solvent content may be defined as 20 to 30 weight % of the total weight of the base slurry BS. Various dispersants may be used as a dispersant contained in the base slurry BS in accordance with required conditions and design specifications. The present disclosure is not restricted or limited by the type and properties of the dispersant.

For example, at least any one of water, ethanol, methanol, isopropanol, xylene, cyclohexanone, acetone, and methyl ethyl ketone may be used as the dispersant.

According to the exemplary embodiment of the present disclosure, the base slurry BS may include the dispersant of 0.1 to 3 weight % with respect to the total weight of the base slurry BS.

If a dispersant content is smaller than 0.1 weight % with respect to the total weight of the base slurry BS, there may occur a problem in which particles of the titanium family elements are aggregated during a process of manufacturing a composition (base slurry). In contrast, if the dispersant content is larger than 3 weight % with respect to the total weight of the base slurry BS, the viscosity of the composition (base slurry) is excessively low to perform a coating process, which may cause a problem in which workability is insufficient.

Therefore, the dispersant content may be defined to as 0.1 to 4 weight % of the total weight of the base slurry BS. Specifically, the coupling agent content may be defined as 1 to 4 weight % of the total weight of the base slurry BS. More particularly, the coupling agent content may be defined as 2 to 3.5 weight % of the total weight of the base slurry BS. Various coupling agents may be used as a coupling agent contained in the base slurry BS in accordance with required conditions and design specifications. The present disclosure is not restricted or limited by the type and properties of the coupling agent.

For example, at least any one of polyvinyl butyral (PVB), polyvinyl alcohol (PVA), polyvinyl chloride (PVC), polyvinyl acetate (PVAc), and polyacrylonitrile may be used as the coupling agent.

According to the exemplary embodiment of the present disclosure, the base slurry BS may include the coupling agent of 0.1 to 5 weight % with respect to the total weight of the base slurry BS.

If a coupling agent content is less than 0.1 weight % with respect to the total weight of the base slurry BS, the binding force between particles of the titanium family elements in the porous base layer is insufficient, which may cause a problem in which the porous base layer cannot maintain a sheet shape. In contrast, if the coupling agent content is more than 5 weight % of the total weight of the base slurry BS, the binding force between the components in the composition (base layer slurry) is too high. This may cause a problem in which the coupling agent attaches to a lower substrate (e.g., the release sheet) during the coating process.

Therefore, the coupling agent content may be defined to be 0.1 to 4 weight % with respect to the total weight of the base slurry BS. Particularly, the coupling agent content may be defined to be 1 to 4 weight % with respect to the total weight of the base slurry BS. More particularly, the coupling agent content may be defined to be 2 to 3.5 weight % with respect to the total weight of the base slurry BS.

The centrifugation part 200 may be provided in the base container 100 to centrifuge the base slurry BS into the first base layer slurry S1 including the first slurry particles and the second base layer slurry S2 including the second slurry particles.

The centrifugation part 200 may have various structures capable of centrifuging the base slurry BS into the first base layer slurry S1 and the second base layer slurry S2. The present disclosure is not restricted or limited by the structure of the centrifugation part 200.

According to the exemplary embodiment of the present disclosure, the centrifugation part 200 may include a centrifugation container 210 provided in the base container 100, spaced apart from an inner surface of the base container 100, and having a mesh portion 212 through which only the first slurry particles may pass among the first and second slurry particles, a centrifugal force application part 220 provided in the base container 100 and configured to apply a centrifugal force to the base slurry BS, and an opening/closing member 230 configured to selectively open or close the mesh portion 212.

The centrifugation container 210 may have various structures capable of accommodating the base slurry BS therein. The present disclosure is not restricted or limited by the structure and shape of the centrifugation container 210.

For example, the centrifugation container 210 may have an approximately hollow cylindrical shape with a smaller diameter than the base container 100. The centrifugation container 210 may be fixed to the base container 100 so that it is spaced apart from the inner surface of the base container 100 at a predetermined interval. According to another embodiment of the present disclosure, the centrifugation container may have a quadrangular box shape or other shapes.

The mesh portion 212 is configured such that only the first slurry particles, which have relatively small particle sizes (first particle sizes) among the first and second slurry particles, pass through the centrifugation container 210 when a centrifugal force is applied to the base slurry BS.

In this case, the configuration in which the first slurry particles pass through the centrifugation container 210 is defined as a configuration in which the first slurry particles move in a radial direction of the centrifugation container 210 from the inside of the centrifugation container 210 to the outside of the centrifugation container 210 (a space between an outer surface of the centrifugation container and an inner surface of the base container).

In addition, when the first slurry particles pass through the mesh portion 212, the other materials (e.g., the solvent, the dispersant, and the coupling agent) having smaller sizes than the first slurry particles may also pass through the mesh portion 212 together with the first slurry particles.

The mesh portion 212 may have various structures capable of allowing the first slurry particles to pass therethrough. The present disclosure is not restricted or limited by the structure and shape of the mesh portion 212.

According to the exemplary embodiment of the present disclosure, the mesh portion 212 may include a plurality of mesh holes 212a through which the first slurry particles may pass.

For example, a typical wire mesh having the plurality of mesh holes 212a may be used as the mesh portion 212. The present disclosure is not restricted or limited by the type and structure of the wire mesh.

The mesh hole 212a may be variously changed in size in accordance with required conditions and design specifications. The present disclosure is not restricted or limited by the size of the mesh hole 212a.

According to the exemplary embodiment of the present disclosure, the mesh hole 212a may have a size (e.g., a width or height) of 5 to 20 μm.

If the size of the mesh hole 212a is smaller than 5 μm, it is difficult to manufacture the mesh portion 212. In contrast, if the size of the mesh hole 212a is larger than 20 μm, the number of slurry particles passing through the mesh hole 212a increases, making it difficult to ensure a sufficient amount of second base layer slurry. Therefore, the size of the mesh hole 212a may be defined as 5 to 20 μm.

The material of the mesh portion 212 and the structure (shape) of the mesh hole 212a may be variously changed in accordance with required conditions and design specifications. The present disclosure is not restricted or limited by the material of the mesh portion 212 and the structure of the mesh hole 212a.

For example, the mesh portion 212 may be made of stainless steel, and passing holes 234a may be provided in the form of approximately quadrangular holes. According to another embodiment of the present disclosure, the mesh portion may be made of other materials such as PE, copper, bronze, or titanium. Alternatively, the mesh hole may have a circular shape, an elliptical shape, a quadrangular shape, or the like.

According to the exemplary embodiment of the present disclosure, the mesh portion 212 may be provided as a plurality of mesh portions 212 spaced apart from one another in a circumferential direction of the centrifugation container 210. For example, three mesh portions 212 may be provided in the centrifugation container 210 and spaced apart from one another at an interval of about 120 degrees in the circumferential direction of the centrifugation container 210.

According to another embodiment of the present disclosure, two or fewer mesh portions 212 or four or more mesh portions may be provided in the centrifugation container.

In the embodiment of the present disclosure illustrated and described above, the example describes a plurality of mesh portions 212 provided to be spaced apart from one another in the circumferential direction of the centrifugation container 210. However, according to another embodiment of the present disclosure, the mesh portion may be provided in the form of a continuous ring formed in the circumferential direction of the centrifugation container.

The centrifugal force application part 220 is provided in the base container 100 to apply the centrifugal force to the base slurry BS.

The centrifugal force application part 220 may have various structures capable of applying the centrifugal force to the base slurry BS. The present disclosure is not restricted or limited by the structure of the centrifugal force application part 220.

According to the exemplary embodiment of the present disclosure, the centrifugal force application part 220 may include a shaft 222 configured to be rotatable relative to the centrifugation container 210, and blades 224 connected to the shaft 222 and configured to rotate the base slurry BS.

For example, the shaft 222 may be mounted in the base container 100 so that one end of the shaft 222 is disposed in the centrifugation container 210. The shaft 222 may be configured to be rotated by a typical drive motor (not illustrated). The present disclosure is not restricted or limited by the type and structure of the driving source of the shaft 222.

The blades 224 are provided to apply the centrifugal force to the base slurry BS by rotating the base slurry BS while rotating together with the shaft 222.

The blade 224 may be variously changed in structure and number in accordance with required conditions and design specifications.

For example, the plurality of blades 224 each having an approximately triangular shape may be provided at a lower end of the shaft 222.

Meanwhile, in the embodiment of the present disclosure illustrated and described above, the example describes applying centrifugal force to the base slurry BS through the rotation of the shaft 222 and the blades 224. However, according to another embodiment of the present disclosure, a centrifugal force may be applied to the base slurry BS by rotating the centrifugation container or the opening/closing member relative to the base container.

The opening/closing member 230 may be configured to selectively open or close the mesh portion 212.

According to the exemplary embodiment of the present disclosure, the opening/closing member 230 may close the mesh portion 212 when the first base layer slurry S1 and the second base layer slurry S2 are separated with the centrifugation container 210 interposed therebetween as the first slurry particles pass through the mesh portion 212 by the centrifugal force applied to the base slurry BS.

The opening/closing member 230 may have various structures capable of selectively opening or closing the mesh portion 212. The present disclosure is not restricted or limited by the structure and operational structure of the opening/closing member 230.

According to the exemplary embodiment of the present disclosure, the opening/closing member 230 may be rotatable from a first position at which the opening/closing member 230 closes the mesh portion 212 to a second position at which the opening/closing member 230 opens the mesh portion 212.

For example, the opening/closing member 230 may include a body portion 232 configured to be rotatable relative to the centrifugation container 210 in the circumferential direction of the centrifugation container 210, and a passage portion 234 provided in the body portion 232 so that the base slurry BS may pass through the passage portion 234. At the first position, the body portion 232 may close the mesh portion 212. At the second position, the passage portion 234 may be disposed to communicate with the mesh portion 212.

The body portion 232 may have various structures capable of rotating relative to the centrifugation container 210 in the circumferential direction of the centrifugation container 210. The present disclosure is not restricted or limited by the structure and shape of the body portion 232.

For example, the body portion 232 may have an approximately hollow cylindrical shape having an outer diameter corresponding to an inner diameter of the centrifugation container 210, and the body portion 232 may be provided in the centrifugation container 210. According to another embodiment of the present disclosure, the body portion may be provided outside the centrifugation container (between the centrifugation container and the base container) instead of inside the centrifugation container.

The passage portion 234 may have various structures capable of allowing the base slurry BS to pass therethrough. The present disclosure is not restricted or limited by the structure and shape of the passage portion 234.

In this case, the configuration in which the base slurry BS passes through the passage portion 234 may be defined as a configuration in which not only the first and second slurry particles included in the base slurry BS pass through the passage portion 234, but also the other materials (e.g., the solvent, the dispersant, and the coupling agent) included in the base slurry BS pass through the passage portion 234.

According to the exemplary embodiment of the present disclosure, the passage portion 234 may include the plurality of passing holes 234a through which the base slurry BS may pass.

For example, a typical wire mesh may be used as the passage portion 234. The present disclosure is not restricted or limited by the type and structure of the wire mesh.

According to the exemplary embodiment of the present disclosure, the passage portion 234 may be provided as a plurality of passage portions 234 spaced apart from one another in the circumferential direction of the body portion 232. For example, three passage portions 234 may be provided in the body portion 232 and spaced apart from one another at intervals of about 120 degrees in the circumferential direction.

According to another embodiment of the present disclosure, two or fewer passage portions or four or more passage portions may be provided in the body portion.

According to the exemplary embodiment of the present disclosure, the apparatus 10 for manufacturing base layer slurry may include a handle part 260 connected to the body portion 232 and configured to rotate the body portion 232.

The handle part 260 may have various structures that allow an operator to grip the handle part 260. The present disclosure is not restricted or limited by the structure and shape of the handle part 260.

For example, the handle part 260 may protrude from an uppermost end of the body portion 232 and have an approximately straight shape. The operator may grip the handle part 260 and rotate the body portion 232 (clockwise or counterclockwise) to selectively open or close the mesh portion 212.

In the embodiment of the present disclosure illustrated and described above, the example has been described in which the rotation of the body portion 232 relative to the centrifugation container 210 is performed manually by the user by using the handle part 260. However, according to another embodiment of the present disclosure, the rotation of the body portion relative to the centrifugation container may be automatically performed by a drive means such as a motor.

Meanwhile, in the embodiment of the present disclosure illustrated and described above, the example has been described in which the opening/closing member 230 rotates from the first position at which the opening/closing member 230 closes the mesh portion 212 to the second position at which the opening/closing member 230 opens the mesh portion 212. However, according to another embodiment of the present disclosure, the opening/closing member may be configured to move rectilinearly from the first position, where it closes the mesh portion, to the second position, where it opens the mesh portion. For example, the opening/closing member may be configured to open or close the mesh portion while moving rectilinearly in an upward/downward direction (axial direction) of the centrifugation container.

According to the exemplary embodiment of the present disclosure, the apparatus 10 for manufacturing base layer slurry may include a cover 250 configured to selectively open or close an opening portion of the body portion 232.

For reference, the opening portion may be formed at an upper side of the body portion 232, and the base slurry BS may be accommodated in the body portion 232 through the opening portion.

The cover 250 may be used to individually extract the first base layer slurry S1 and the second base layer slurry S2 separated with the centrifugation container 210 interposed therebetween.

For example, in a state in which the first base layer slurry S1 and the second base layer slurry S2 are centrifuged with the centrifugation container 210 interposed therebetween (a state in which the opening/closing member closes the mesh portion), the cover 250 is coupled to cover the opening portion of the body portion 232, such that only the first base layer slurry S1 may be extracted from the base container 100.

After the first base layer slurry S1 is extracted from the base container 100, the cover 250 may be separated, allowing the second base layer slurry S2 to be extracted from the centrifugation container 210. Alternatively, the second base layer slurry S2 may be extracted from the centrifugation container 210 through a discharge hole (not illustrated) provided in the cover 250.

Hereinafter, a method of manufacturing the porous base layer according to the embodiment of the present disclosure will be described.

A method of manufacturing base layer slurry for forming a porous base layer includes a step of preparing the base slurry BS including the first slurry particles and the second slurry particles having larger particle sizes than the first slurry particles, and a step of centrifuging the base slurry BS into the first base layer slurry S1 including the first slurry particles and the second base layer slurry S2 including the second slurry particles.

### STEP 1

First, the base slurry BS including the first slurry particles and the second slurry particles having larger particle sizes than the first slurry particles is prepared.

The base slurry BS may be provided by mixing various materials together with the first slurry particles and the second slurry particles in accordance with required conditions and design specifications. The present disclosure is not restricted or limited by the types of materials, which constitute the base slurry BS, and the composition ratios of the materials.

For example, the base slurry BS may be provided by mixing the first slurry particles (e.g., metal elements), the second slurry particles (e.g., metal elements), solvents, dispersants, and coupling agents.

Various metal elements may be used as the metal element in accordance with required conditions and design specifications.

According to the exemplary embodiment of the present disclosure, the metal element may include a titanium family element. More particularly, titanium family elements may include at least any one of titanium, zirconium, and hafnium.

### STEP 2

Next, the base slurry BS is centrifuged into the first base layer slurry S1 including the first slurry particles and the second base layer slurry S2 including the second slurry particles.

The method of centrifuging the base slurry BS into the first base layer slurry S1 and the second base layer slurry S2 may be implemented in various ways in accordance with required conditions and design specifications. The present disclosure is not restricted or limited by the method of centrifuging the base slurry BS into the first base layer slurry S1 and the second base layer slurry S2.

For example, the step of centrifuging the base slurry BS into the first base layer slurry S1 and the second base layer slurry S2 may be performed by using the centrifugation part 200. This includes the centrifugation container 210, which is provided in the base container 100, spaced apart from the inner surface of the base container 100, and the mesh portion 212 through which only the first slurry particles may pass among the first and second slurry particles. It also includes the centrifugal force application part 220, which is provided in the base container 100 and configured to apply the centrifugal force to the base slurry BS, and the opening/closing member 230, which is configured to selectively open or close the mesh portion 212.

According to the exemplary embodiment of the present disclosure, the opening/closing member 230 may be rotatable from the first position at which the opening/closing member 230 closes the mesh portion 212 to the second position at which the opening/closing member 230 opens the mesh portion 212.

For example, the opening/closing member 230 may include the body portion 232 configured to be rotatable relative to the centrifugation container 210 in the circumferential direction of the centrifugation container 210, and the passage portion 234 provided in the body portion 232 so that the base slurry BS may pass through the passage portion 234. At the first position, the body portion 232 may close the mesh portion 212. At the second position, the passage portion 234 may be disposed to communicate with the mesh portion 212.

In addition, according to the exemplary embodiment of the present disclosure, the centrifugal force application part 220 may include the shaft 222 configured to be rotatable relative to the centrifugation container 210, and the blades 224 connected to the shaft 222 and configured to rotate the base slurry BS.

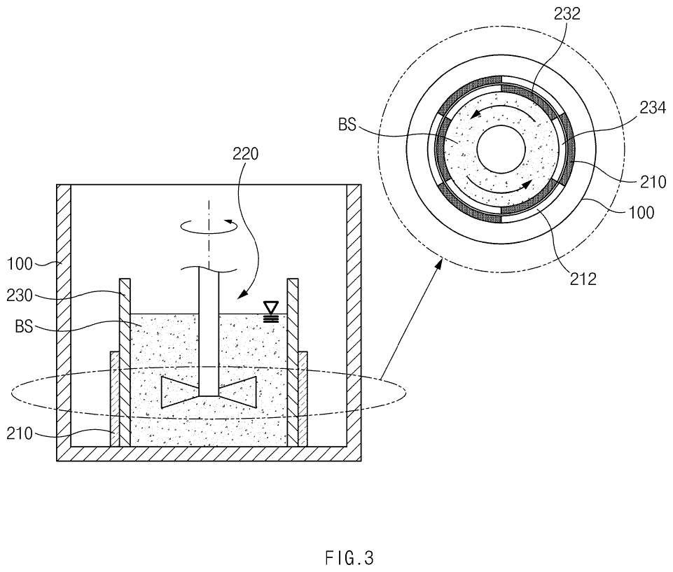

First, as illustrated in FIG. 3, in a state in which the centrifugation container 210 and the opening/closing member 230 are disposed in the base container 100, the prepared base slurry BS is injected into the centrifugation container 210.

At the time of injecting the base slurry BS into the centrifugation container 210, the body portion 232 is disposed to close the mesh portion 212.

With reference to FIG. 3, in the state in which the base slurry BS is injected into the centrifugation container 210, the base slurry BS may be agitated (mixed) under a particular condition.

The agitation of the base slurry BS may be implemented in various ways in accordance with required conditions and design specifications. The present disclosure is not restricted or limited by the method of agitating the base slurry BS.

For example, the agitation of the base slurry BS may be performed by the centrifugal force application part 220, which is configured to apply the centrifugal force to the base slurry BS.

For example, an agitation time for the base slurry BS may be defined to be 10 to 30 minutes, and a rotational speed of the shaft 222 (or blade) may be defined to be 5,000 to 9,000 rpm. More particularly, the agitation time for the base slurry BS may be defined to be 15 to 25 minutes, and the rotational speed of the shaft 222 (or blade) may be defined to be 6,000 to 8,000 rpm.

In the embodiment of the present disclosure illustrated and described above, the example has been described in which the agitation of the base slurry BS is performed by the centrifugal force by using the shaft 222 and the blades 224. However, according to another embodiment of the present disclosure, the base slurry BS may be agitated by using at least any one of a homo mixer, an ultrasonic disperser, a homogenizer, and a planetary mixer.

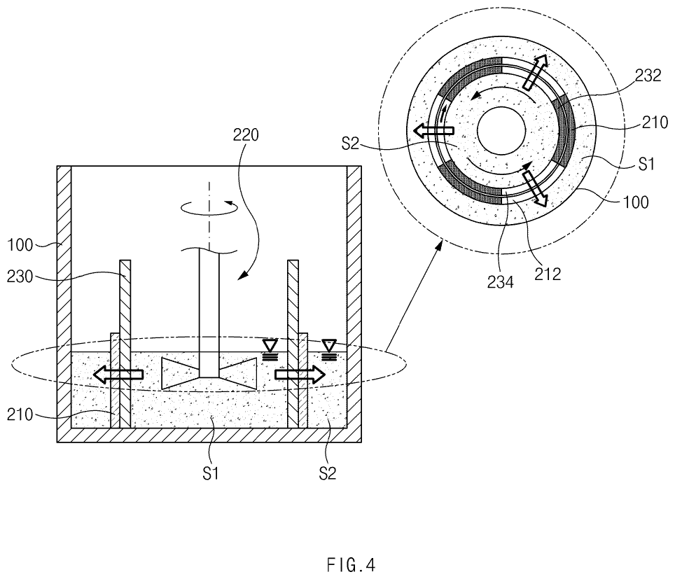

Next, after the base slurry BS is agitated under a preset condition, the base slurry BS may be centrifuged into the first base layer slurry S1 and the second base layer slurry S2 by applying the centrifugal force to the base slurry BS in the state in which the mesh portion 212 is opened, as illustrated in FIG. 4.

That is, when the centrifugal force is applied to the base slurry BS in the state in which the mesh portion 212 is opened, only the first slurry particles, among the first and second slurry particles, pass through the mesh portion 212. This allows the first base layer slurry S1 and the second base layer slurry S2 to be separated with the centrifugation container 210 interposed therebetween.

The method of manufacturing a base layer slurry according to the exemplary embodiment of the present disclosure may include a step of structurally blocking the first base layer slurry S1 and the second base layer slurry S2.

In the step of structurally blocking the first base layer slurry S1 and the second base layer slurry S2, the first base layer slurry S1 and the second base layer slurry S2 are structurally blocked in the state in which the base slurry BS is centrifuged into the first base layer slurry S1 and the second base layer slurry S2.

In this case, the configuration in which the first base layer slurry S1 and the second base layer slurry S2 are structurally blocked is defined as a configuration in which a portion between the first base layer slurry S1 and the second base layer slurry S2 is structurally (spatially) blocked so that the first base layer slurry S1 and the second base layer slurry S2, which have been centrifuged, are not mixed again.

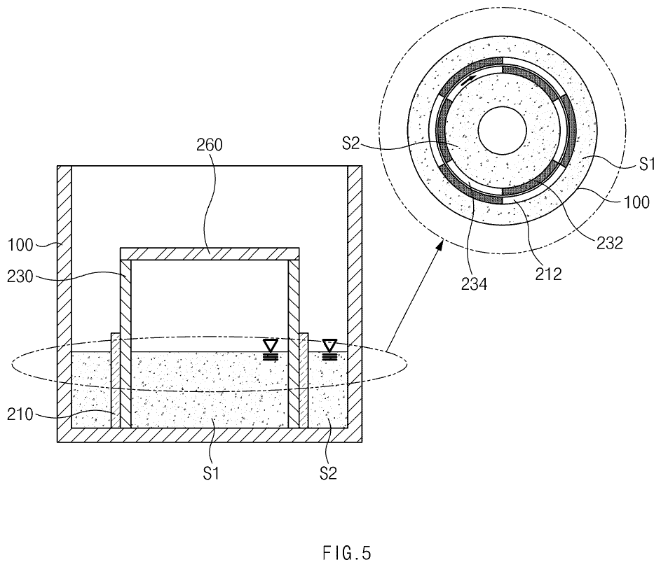

For example, with reference to FIG. 5, the first base layer slurry S1 and the second base layer slurry S2 may be structurally blocked by rotating the body portion 232 (e.g., clockwise) relative to the centrifugation container 210 so that the body portion 232 closes the mesh portion 212 in the state in which the base slurry BS is centrifuged into the first base layer slurry S1 and the second base layer slurry S2.

The method of manufacturing a base layer slurry according to the exemplary embodiment of the present disclosure may include a step of individually extracting the first base layer slurry S1 and the second base layer slurry S2.

The method of individually extracting the first base layer slurry S1 and the second base layer slurry S2 may be variously changed in accordance with required conditions and design specifications. The present disclosure is not restricted or limited by the method of extracting the first base layer slurry S1 and the second base layer slurry S2.

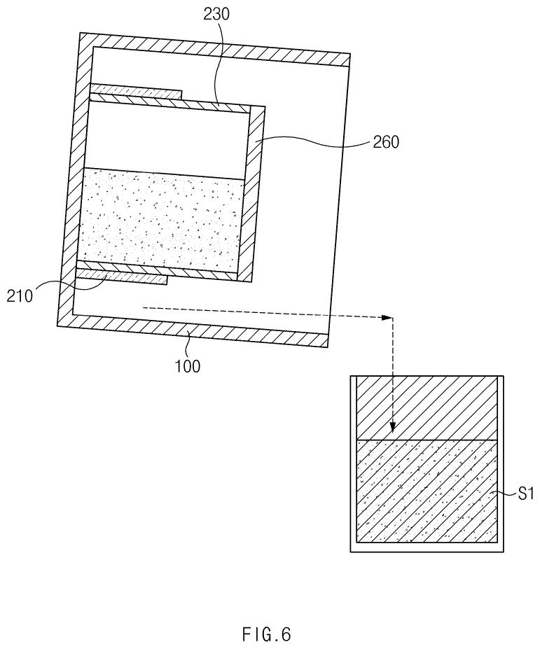

For example, with reference to FIG. 6, in a state where the first base layer slurry S1 and the second base layer slurry S2 are centrifuged with the centrifugation container 210 interposed therebetween (a state in which the opening/closing member closes the mesh portion), the cover 250 is coupled to cover the opening portion of the body portion 232. This configuration allows only the first base layer slurry S1 to be extracted from the base container 100 first.

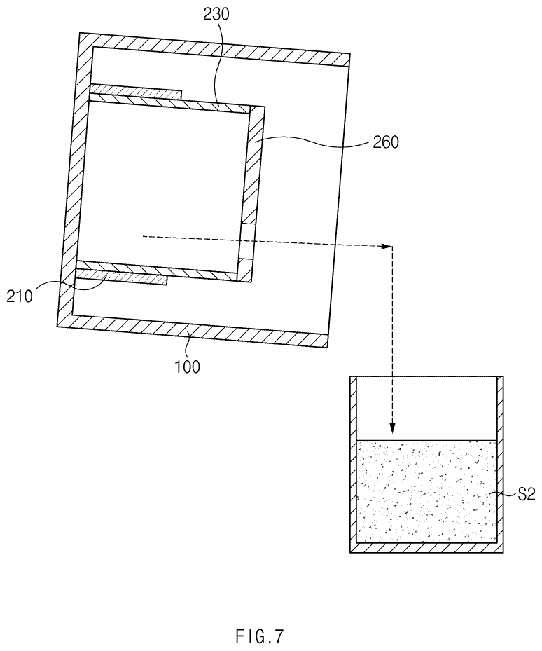

Next, as illustrated in FIG. 7, the second base layer slurry S2 may be extracted from the centrifugation container 210 through the discharge hole (not illustrated) provided in the cover 250.

Meanwhile, the first base layer slurry S1 may be applied onto the release sheet, and the release sheet may be separated after the first base layer slurry S1 is cured (solidified), such that the first base layer 42 may be formed.

In the above-mentioned way, the second base layer slurry S2 may be applied onto the release sheet, and the release sheet may be separated after the second base layer slurry S2 is cured (solidified), such that the second base layer 44 may be formed.

Meanwhile, the first and second base layers 42 and 44, which are separated from the release sheet, may be cut into predefined dimensions and then subjected to a heat treatment process (a degreasing process and a sintering process).

The process of degreasing the first base layer 42 and the second base layer 44 may be performed at various temperatures at which the solvent in the first base layer 42 and the second base layer 44 may be removed.

According to the exemplary embodiment of the present disclosure, the process of degreasing the first base layer 42 and the second base layer 44 may be performed under a condition of 300 to 700° C. at an inert gas ambience.

If a temperature of the process of degreasing the first base layer 42 and the second base layer 44 is lower than 300° C., there may be a problem with the solvent not being fully evaporated. In contrast, if the temperature of the degreasing process is higher than 700° C., there may be a problem with the titanium family element becoming oxidized in an environment that is not a high-vacuum ambience.

Therefore, the temperature of the process of degreasing the first base layer 42 and the second base layer 44 may be defined to be 300 to 700° C. In particular, the temperature of the process of degreasing the first base layer 42 and the second base layer 44 may be defined to be 350 to 600° C. More particularly, the temperature of the process of degreasing the first base layer 42 and the second base layer 44 may be defined to be 400 to 500° C.

An inert gas used for the process of degreasing the first base layer 42 and the second base layer 44 may be variously changed in types and properties in accordance with required conditions and design specifications. The present disclosure is not restricted or limited by the type and properties of the inert gas. For example, argon (Ar) gas may be used as the inert gas. For reference, the process of degreasing the first base layer 42 and the second base layer 44 may raise the temperature at 1 to 3° C./min and be maintained at the corresponding temperature for 2 hours.

The process of sintering the first base layer 42 and the second base layer 44 may be performed under various temperature and pressure conditions in accordance with required conditions and design specifications.

According to the exemplary embodiment of the present disclosure, the process of sintering the first base layer 42 and the second base layer 44 may be performed under a temperature condition of 900 to 1,500° C. and a pressure condition of 1×10⁻⁵ Torr or less.

If a temperature of the process of sintering the first base layer 42 and the second base layer 44 is lower than 900° C., the titanium family element in the first base layer 42 and the second base layer 44 is not adequately sintered. This can cause problems such as excessively large pores or low rigidity. In contrast, if the temperature of the process of sintering the first base layer 42 and the second base layer 44 is higher than 1500° C., the titanium family element in the first base layer 42 and the second base layer 44 is excessively sintered, leading to clogged pores.

In addition, if the pressure of the process of sintering the first base layer 42 and the second base layer 44 is in a low-vacuum state (e.g., higher than 1×10⁻⁵ Torr), there may occur a problem in that the titanium family element in the first base layer 42 and the second base layer 44 is oxidized, or the first base layer 42 and the second base layer 44 are contaminated by contaminants in a sintering furnace. In contrast, if the pressure of the process of sintering the first base layer 42 and the second base layer 44 is in a high-vacuum state higher than necessary (e.g., lower than 1×10⁻⁸ Torr), a high-specification vacuum pump and device are required, which may cause a problem in which process costs and process time increase.

Therefore, the process of sintering the first base layer 42 and the second base layer 44 may be performed under a temperature condition of 900 to 1,500° C. and a pressure condition of 1×10⁻⁵ Torr or less. In particular, the process of sintering the first base layer 42 and the second base layer 44 may be performed under a temperature condition of 950 to 1,300° C. and a vacuum condition of 1×10⁻⁵ to 1×10⁻⁸ Torr. More particularly, the process of sintering the first base layer 42 and the second base layer 44 may be performed under a temperature condition of 950 to 1,250° C. and a pressure condition of 1×10⁻⁶ to 5×10⁻⁷ Torr.

Thereafter, heat (e.g., 60 to 80° C.) and pressure (e.g., 0.1 to 1.5 MPa) are applied (surface pressing or rolling) while the first base layer 42 and the second base layer 44 are stacked. This results in that the formation of the porous base layer 40, in which the first base layer 42 and the second base layer 44 are integrally connected.

According to the embodiment of the present disclosure described above, it is possible to obtain an advantageous effect of simplifying the structure and manufacturing process and improving the productivity.

In particular, according to the embodiment of the present disclosure, it is possible to obtain an advantageous effect of simplifying the process of manufacturing different types of base layer slurry including slurry particles having different particle sizes, and improving the productivity and production efficiency.

Among other things, according to the embodiment of the present disclosure, it is possible to simultaneously manufacture the first base layer slurry including the first slurry particles and the second base layer slurry including the second slurry particles having larger particle sizes than the first slurry particles by means of the single process.

In addition, according to the embodiment of the present disclosure, it is possible to obtain an advantageous effect of reducing the costs and minimizing the time required to produce different types of base layer slurry.

In addition, according to the embodiment of the present disclosure, it is possible to obtain an advantageous effect of improving the safety and reliability and minimizing the risk of the occurrence of a fire in accordance with the classification of slurry particles.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. An apparatus for manufacturing base layer slurry for forming a porous base layer, the apparatus comprising:
a base container configured to accommodate base slurry comprising first slurry particles, and second slurry particles having larger particle sizes than the first slurry particles; and
a centrifugation part configured to centrifuge the base slurry into first base layer slurry comprising the first slurry particles and second base layer slurry comprising the second slurry particles.

2. The apparatus of claim 1, wherein the centrifugation part comprises:
a centrifugation container provided in the base container and comprising a mesh portion through which only the first slurry particles, among the first and second slurry particles, pass;
a centrifugal force application part configured to apply a centrifugal force to the base slurry; and
an opening/closing member configured to selectively open or close the mesh portion.

3. The apparatus of claim 2, wherein the opening/closing member is configured to close the mesh portion when the first base layer slurry and the second base layer slurry are separated with the centrifugation container interposed therebetween.

4. The apparatus of claim 2, wherein the mesh portion comprises a plurality of mesh holes through which the first slurry particles pass.

5. The apparatus of claim 2, wherein the mesh portion is provided as a plurality of mesh portions spaced apart from one another in a circumferential direction of the centrifugation container.

6. The apparatus of claim 2, wherein the opening/closing member is rotatable from a first position at which the opening/closing member closes the mesh portion to a second position at which the opening/closing member opens the mesh portion.

7. The apparatus of claim 6, wherein the opening/closing member comprises:
a body portion configured to be rotatable relative to the centrifugation container in a circumferential direction of the centrifugation container; and
a passage portion provided in the body portion so that the first slurry particles pass through the passage portion, and
wherein the body portion closes the mesh portion at the first position, and the passage portion is disposed to communicate with the mesh portion at the second position.

8. The apparatus of claim 7, wherein the body portion is rotatable in the centrifugation container.

9. The apparatus of claim 7, further comprising:
a cover configured to selectively open or close an opening portion of the body portion.

10. The apparatus of claim 7, further comprising:
a handle part connected to the body portion and configured to rotate the body portion.

11. The apparatus of claim 2, wherein the centrifugal force application part comprises:
a shaft configured to be rotatable relative to the centrifugation container; and
a blade connected to the shaft and configured to rotate the base slurry.

12. An apparatus comprising:
a container comprising a mesh portion, and
an opening/closing member configured to selectively open or close the mesh portion.

13. The apparatus of claim 12, wherein the mesh portion is provided as a plurality of mesh portions spaced apart from one another in a circumferential direction of the container.

14. The apparatus of claim 12, wherein the opening/closing member is rotatable from a first position at which the opening/closing member closes the mesh portion to a second position at which the opening/closing member opens the mesh portion.

15. The apparatus of claim 12, wherein the opening/closing member is rotatable inside the container.

16. A method of manufacturing base layer slurry for forming a porous base layer, the method comprising:
preparing base slurry comprising first slurry particles, and second slurry particles having larger particle sizes than the first slurry particles; and
placing the base slurry in a container with a mesh portion configured to allow only the first slurry particles to pass through;
applying a centrifugal force to the base slurry to separate the first and second slurry particles;
selectively open or close the mesh portion using an opening/closing mechanism to control a passage of the first slurry particles.

17. The method of claim 16, further comprising:
blocking the first base layer slurry and the second base layer slurry by closing the mesh portion during the centrifuging to keep the base slurry separated.

18. The method of claim 16, further comprising:
individually extracting the first base layer slurry and the second base layer slurry after the centrifuging by using a cover to selectively open or close an opening portion of the container.

19. The method of claim 16, wherein the mesh portion is provided as a plurality of mesh portions spaced apart from one another in a circumferential direction of the container.

20. The method of claim 16, wherein the opening/closing member is rotatable from a first position at which the opening/closing member closes the mesh portion to a second position at which the opening/closing member opens the mesh portion.
